(19) United States
(12) Patent Application Publication
(10) Pub. No.: US 2017/0374369 A1
(43) Pub. Date: Dec. 28, 2017

(54) Methods and Apparatuses of Decoder Side Intra Mode Derivation

(71) Applicant: MEDIATEK INC., Hsin-Chu (TW)

(72) Inventors: Tzu-Der CHUANG, Zhubei City (TW); Ching-Yeh CHEN, Taipei City (TW); Yu-Wen HUANG, Taipei City (TW); Jing YE, San Jose, CA (US); Shan LIU, San Jose, CA (US); Xiaozhong XU, State College, PA (US); Jungsun KIM, San Jose, CA (US)

(21) Appl. No.: 15/629,877

(22) Filed: Jun. 22, 2017

Related U.S. Application Data
(60) Provisional application No. 62/354,140, filed on Jun. 24, 2016.
(60) Provisional application No. 62/365,403, filed on Jul. 22, 2016.

(51) Int. Cl. H04N 19/159; H04N 19/593; H04N 19/176; H04N 19/70; H04N 19/105

(52) U.S. Cl. CPC H04N 19/159; H04N 19/70; H04N 19/105; H04N 19/176; H04N 19/593

(57) ABSTRACT

Video processing methods and apparatuses receive input data associated with a current block, determine an actual intra prediction mode for the current block by performing decoder side intra mode derivation, perform intra prediction based on the actual intra prediction mode, replace the actual intra prediction mode with a pseudo mode when processing the current block by an intra mode dependent tool in syntax signaling or parsing, and encode or decode the current block. The pseudo mode referenced by the intra mode dependent tool is a predefined mode or a derived mode, which is referenced as the intra prediction mode for blocks coded using decoder side intra mode derivation, or is referenced by the intra mode dependent tool as the intra prediction mode for all intra prediction coded blocks.

### CROSS REFERENCE TO RELATED APPLICATIONS

The present invention claims priority to U.S. Provisional Patent Application, Ser. No. 62/354,140, filed on Jun. 24, 2016, entitled “Methods for template base intra prediction in image and video compression”, and U.S. Provisional Patent Application, Ser. No. 62/365,403, filed on Jul. 22, 2016, entitled “Methods for template based intra prediction in image and video compression”. The U.S. Provisional Patent Applications are hereby incorporated by reference in their entireties.

### FIELD OF THE INVENTION

The present invention relates to video data processing methods and apparatuses encode or decode video data. In particular, the present invention relates to video data processing methods and apparatuses encode or decode video data using decoder side intra mode derivation.

### BACKGROUND AND RELATED ART

Intra prediction has been widely adopted in various image and video coding standards to process an initial picture or to periodically insert I-picture or I-blocks for random access or for alleviation of error propagation. Intra prediction is designed to exploit spatial features in the picture such as smooth areas, vertical lines or edges, horizontal lines or edges, and diagonal lines or edges. Intra prediction is also useful for regions with high motion or scene changes. For a block-based video coding standard, intra prediction for a current block is relied upon pixels in neighboring blocks that have been processed. For example, if blocks in a picture or picture region are sequentially processed row by row from top to bottom and from left to right, neighboring blocks on the top and neighboring blocks on the left of the current block can be used to derive an intra predictor for pixels in the current block.

The High-Efficiency Video Coding (HEVC) standard supports 35 intra prediction modes including 33 angular modes, DC mode, and Planar mode. FIG. 1 illustrates the prediction directions for the 33 angular intra prediction modes disclosed in the HEVC standard, where H represents horizontal mode and V represents vertical mode. An intra predictor for a current block coded or to be coded by intra prediction in the HEVC standard is generated by three steps including intra smoothing filter, intra prediction, and intra gradient filter. FIG. 2 illustrates exemplary reference samples 22 filtered by an intra smoothing filter for deriving an intra predictor for a current block 20. A smoothing operation is applied to reference samples 22 of the current block 20 before calculating the intra predictor for the current block 20. The smoothing operation reduces the discontinuities introduced by some of the intra prediction modes by applying the intra smoothing filter to the reference samples 22 in a left neighboring column and an above neighboring row of the current block 20. This smoothing operation is adaptively applied depending on an intra prediction mode and the size of the current block.

The second step is to derive the intra predictor from neighboring reference samples according to one intra prediction mode selected from the 35 intra prediction modes. If an angular mode is selected, the value of each sample in the current block is predicted by extrapolating the samples from the neighboring reference samples according to the prediction direction of the selected angular mode. In Planar mode is selected, the value of each sample in the current block is calculated assuming an amplitude surface with a horizontal and vertical smooth gradient is derived from the boundary samples of the neighboring blocks. The value of each sample of the current block is an average of the reference samples if DC mode is selected.

An intra gradient filter is applied to samples at the left and top boundaries of the current block in the third step if the intra prediction mode is DC, horizontal, or vertical mode. The concept of applying the intra gradient filter is to utilize the gradient information along the intra prediction direction to improve the quality of the intra predictor. The samples in the first row and first column of the current block are filtered by the intra gradient filter when the selected intra prediction mode is DC mode. The samples in the first row are filtered by the intra gradient filter when the selected intra prediction mode is horizontal mode, and the samples in the first column are filtered by the intra gradient filter if the selected intra prediction mode is vertical mode.

The selected intra prediction mode is signaled explicitly or inferred from previously decoded modes of the above and left neighboring blocks of the current block. The intra prediction modes of the two neighboring blocks are included in a set of three Most Probable Modes (MPMs). In cases when the intra prediction modes of the two neighboring blocks are identical and both are angular modes, or when only the intra prediction mode of one neighboring block is available and is an angular mode, two neighboring directions immediately next to the angular mode are included in the MPM set. DC mode and Planar mode are considered to fill the available spot in the MPM set in some other cases. A first MPM flag is signaled to indicate whether the selected mode is identical to one of the three MPMs in the MPM set, if so, another flag is sent to indicate which of the three MPMs is selected; if the first MPM flag is false, the selected mode is explicitly signaled by a remaining mode index using a 5-bit fixed length codeword.

The 33 angular modes shown in FIG. 1 can be expanded to a general case with more or less angular modes, where each of the angular modes can be represented by mode H+k or mode V+k, where H represents the direction of horizontal mode, V represents the direction of vertical mode, and k=0, +−1, +−2, . . . +−K. An example of 65 angular modes for intra prediction is shown in FIG. 3, where k is ranged from −16 to 16. Mode H−16 and mode V−16 are the same mode as this mode refers to the prediction direction from an upper-left corner to the center of the current block. FIG. 3 illustrates the 65 angular intra prediction modes with additional 32 angular modes in between the original 33 angular modes of HEVC. The 65 angular modes in FIG. 3 include modes H+16 to H−15 from bottom to top at the left boundary of the block and modes V−16 to V±16 from left to right at the upper boundary of the block.

After obtaining an intra predictor for a current block, prediction errors computed between the current block and the intra predictor are further processed by transform and quantization and then encoded by an entropy coding engine. In the entropy coding engine, the quantized coefficients are divided into multiple 4×4 coefficient groups. A coding order of different coefficient groups and a scan order of coefficients in one coefficient group for a current block are selected according to the intra prediction mode of the current block and the transform size. Intra-mode-dependent coefficient scan is used for the coding order of different coefficient groups and the scan order of coefficients in one coefficient group if the transform size is smaller than or equal to 8×8; otherwise diagonal scan is used as the default scan for the coding order of different coefficient groups and the scan order of coefficients in one coefficient group.

A template based Decoder side Intra Mode Derivation (DINED) method is disclosed in JVET-C0061 (X. Xiu, etc., “Decoder-side intra mode derivation”, in Joint Video Exploration Team (JVET) of ITU-T SG16 WP3 and ISO/TEC JTC1/SC29/WG11 3^{rd} Meeting: Geneva, CH, 26 May-1 June, 2016, Document: WET-C0061). NET is established by both ITU-T VCEG and ISO/TEC MPEG to set the next generation video coding technologies. The presented MID method is a template based intra prediction, where neighboring reconstructed samples around a current block are used as a template, and reconstructed samples in the template are compared with prediction samples in same positions. The prediction samples are generated using template reference pixels which are the neighboring reconstructed pixels around the template. FIG. 4 illustrates a template used for deriving an intra prediction mode for a current block according to the Decoder side Intra Mode Derivation (DIMD) method, where the template 42 for a N×N current block 40 has two segments, one on the top of the current block 40 with a size N×L, and one to the left of the current block 40 with a size L×N. L can be determined according to the block size of the current block. Template reference pixels 44 refer to a set of neighboring samples from above and left of the template 42. The width of the template reference pixels 44 above the template 42 on the top of the current block 40 is 2(L+N)+1, and the height of the template reference pixels 44 on the left of the template 42 on the left of the current block 40 is also 2(L+N)+1. For each possible intra prediction mode, the encoder and decoder try to generate the prediction samples in a similar way for the positions in the template 42. The encoder and decoder calculate an absolute difference between the reconstructed samples of the template 42 and its prediction samples obtained from the template reference pixels 44 with respect to each possible intra prediction mode, and the intra prediction mode with the minimum absolute difference is selected as the best intra prediction mode. The DIMD method disclosed in JVET-00061 uses the best intra prediction mode as the actual intra prediction mode for coding a current block when the block size of the current block is 2N×2N; when the block size of the current block is N×N, the best intra prediction mode derived by the DIMD method is put in the MPM set, and a redundant MPM in the MPM set may be removed.

Reference software called Joint Exploration Model (TEM) is built up in WET based on HEVC's reference software (HM), which includes new video coding tools such as 67 intra prediction modes, Quad-Tree-Binary-Tree (QTBT) structure, Enhanced Multiple Transform (EMT), and Non-Separable Second Transform (NSST). In JEM, the 67 intra prediction modes including the 65 angular modes shown in FIG. 3, DC mode, and Planar mode, are used to replace the 35 intra prediction modes in HEVC. During the template matching search of the DIMD method disclosed in WET-00061, available intra prediction modes increase from 67 modes to 131 modes to increase the precision of intra prediction. The intra prediction mode selected from the 131 modes for a DIMD coded block is first mapped back to one of the 67 modes, and the mapped mode is stored in an intra mode buffer for MPM derivation, coefficient scan, EMT, NSST, and Residual Differential Pulse-Code Modulation (RDPCM). The intra prediction mode derived by the DIMD method is stored in a new buffer for intra prediction. The interpolation filter for reference samples applied in intra prediction increase from 1/32-pel to 1/64-pel.

The QTBT structure implemented in JEM combines a quad-tree partitioning method with a binary-tree partitioning method, which balances the coding efficiency and the coding complexity of the two partitioning methods, An exemplary QTBT structure is shown in FIG. 5A, where a large block is firstly partitioned by a quad-tree partitioning method then a binary-tree partitioning method. FIG. 5A illustrates an example of block partitioning structure according to the QTBT partitioning method and FIG. 5B illustrates a coding tree diagram for the QTBT block partitioning structure shown in FIG. 5A. The solid lines in FIGS. 5A and 5B indicate quad-tree splitting while the dotted lines indicate binary-tree splitting. In each splitting (i.e., non-leaf) node of the binary-tree structure, one flag indicates which splitting type (symmetric horizontal splitting or symmetric vertical splitting) is used, 0 indicates horizontal splitting and 1 indicates vertical splitting. The QTBT structure in FIG. 5A splits the large block into multiple smaller blocks, and these smaller blocks may be processed by prediction and transform coding without further splitting. In an example, the large block in FIG. 5A is a coding tree unit (CTU) with a size of 128×128, a minimum allowed quad-tree leaf node size is 16×16, a maximum allowed binary-tree root node size is 64×64, a minimum allowed binary-tree leaf node width or height is 4, and a minimum allowed binary-tree depth is 4. In this example, the leaf quad-tree block may have a size from 16×16 to 128×128, and if the leaf quad-tree block is 128×128, it cannot be further split by the binary-tree structure since the size exceeds the maximum allo wed binary-tree root node size 64×64. The leaf quad-tree block is used as the root binary-tree block that has a binary-tree depth equal to 0. When the binary-tree depth reaches 4, non-splitting is implicit; when the binary-tree node has a width equal to 4, non-vertical splitting is implicit; and when the binary-tree node has a height equal to 4, non-horizontal splitting is implicit. For CTUs coded in I slice, the QTBT block partitioning structure for two chroma coding tree blocks (CTBs) can be different from the QTBT block partitioning structure for a corresponding luma CTB. For CTUs coded in P or B slice, the same QTBT block partitioning structure may be applied to both chroma. CTBs and luma CTB.

### BRIEF SUMMARY OF THE INVENTION

Methods and apparatuses of processing video data in a video coding system comprise receive input data associated with a current block of the video data, determine an actual intra prediction mode for the current block by performing decoder side intra mode derivation, perform intra prediction for the current block based on the actual intra prediction mode, and encode or decode the current block. The decoder side intra mode derivation is an intra mode derivation method that determines the actual intra prediction mode for the current block without referencing original samples of the current block. The decoder side intra mode derivation can therefore be implemented in both encoders and decoders so the encoders and decoders derive the same actual intra prediction mode for the current block without signaling an index for the actual intra prediction mode. The decoder side intra mode derivation reduces the data bits required for intra mode signaling as intra prediction modes are not explicitly signaled. An example of the decoder side intra mode derivation is template based intra mode prediction. Template based intra mode prediction selects one mode as the actual intra prediction mode according to a difference between reconstructed samples and prediction samples of a template around the current block. Decoders derive the intra prediction modes after reconstructing neighboring samples of the current block so the intra prediction mode may not be available in the parsing stage. In order to solve the parsing issue caused by the intra mode dependent tools and the decoder side intra mode derivation, the actual intra prediction mode derived by the decoder side intra mode derivation is replaced with a pseudo mode when referencing an intra prediction mode of the current block by an intra mode dependent tool, for example, the pseudo mode is used to derive at least one of a coefficient scan order and sign hiding for the current block coded using decoder side intra mode derivation.

In one embodiment, the pseudo mode is a predefined mode such as DC mode, Planar mode, vertical mode, horizontal mode, or diagonal mode. In another embodiment, the pseudo mode is a derived mode determined according to a predefined method, for example, the derived mode is derived from one or more neighboring intra prediction modes or the derived mode is set as a Most Probable Mode (MPM) candidate in a MPM set derived for the current block.

Embodiments of the video processing methods with decoder side intra mode derivation determine whether the current block is coded using the decoder side intra mode derivation or non-decoder side intra mode derivation by an explicit flag signaled in a video bitstream. The non-decoder side intra mode derivation is an intra prediction method which determines an actual intra prediction mode of a current block using original samples of the current block. The encoder determines intra prediction modes using the non-decoder side intra mode derivation and then signals the intra prediction modes to the decoder. An example of the non-decoder side intra mode derivation is the conventional intra prediction method adopted in the HEVC or H.264/AVC standard.

The intra mode dependent tool referencing the pseudo mode as the intra prediction mode of the current block may be one or a combination of intra-mode-dependent coefficient scan, Residual Differential Pulse-Code Modulation (RDPCM), Non-Separable Second Transform (NSST), Enhanced Multiple Transform (EMT), Reference Sample Adaptive Filter (RSAF), and Most Probable Mode (MPM) derivation. For example, sign hiding is disabled for the current block coded using the decoder side intra mode derivation when transform skip mode and RDPCM are used according to an embodiment. In another embodiment, the pseudo mode is referenced in transform or inverse transform of the current block, and two transform NSST is used for encoding or decoding the current block. In yet another embodiment, the pseudo mode is referenced for deriving a coefficient scan order or sign hiding but the actual intra prediction mode derived by the decoder side intra mode derivation is referenced for performing transform, EMT, NSST, or RSAF for the current block.

In some embodiments, the pseudo mode is referenced to deriving a MPM set for a neighboring block of the current block when the current block is coded using the decoder side intra mode derivation. In another embodiments, the intra prediction mode of the current block is marked as unavailable for deriving a MPM set for a neighboring block of the current block when the current block is coded using the decoder side intra mode derivation.

A variation of the embodiments references a pseudo mode by one or more coding tools in the parsing stage and uses a second pseudo mode by one or more coding tools in a reconstruction stage, where the coding tools in the reconstructing stage include EMT, NSST, and RSAF. The pseudo mode and the second pseudo mode are either set to be the same mode or different modes.

Some embodiments unify the parsing for blocks coded using decoder side intra mode derivation and blocks coded using non-decoder side intra mode derivation by always replacing the intra prediction mode with a pseudo mode in the parsing stage. The pseudo mode is referenced by an intra-mode-dependent coding tool for both blocks coded using decoder side intra mode derivation and non-decoder side intra mode derivation. In one embodiment, the pseudo mode is referenced for both blocks coded using the decoder side intra mode derivation and non-decoder side intra mode derivation only if the decoder side intra mode derivation is enabled, for example, the decoder side intra mode derivation is enabled in CTU, slice, picture, or sequence level; else an actual intra prediction mode derived by the non-decoder side intra mode derivation is referenced if the decoder side intra mode derivation is disabled.

A variation of the embodiments treats the decoder side intra mode derivation as one special mode by assigning a predefined intra prediction mode index to a current block coded using the decoder side intra mode derivation, and applying the same intra prediction mode signaling to both blocks coded using the decoder side intra mode derivation and non-decoder side intra mode derivation. For example, the intra prediction mode signaling for blocks coded using decoder side intra mode derivation and non-decoder side intra mode derivation transmits a MPM flag followed by a MPM index or a remaining mode index.

In some embodiments, the actual intra prediction mode derived by the decoder side intra mode derivation is referenced by blocks in a different Coding Tree Unit (CTU) or a different CTU-row while the pseudo mode is referenced by blocks in a same GM or CTU-row as the current block. Blocks in an upper CTU or an upper CTU-row are reconstructed when processing the current block and therefore the actual intra prediction modes of intra coded blocks in the upper CTU or upper CTU-row are ready to be referenced.

Video processing methods and apparatus may apply decoder side intra mode derivation to refine a coarse grain intra prediction mode according to some embodiments of the present invention. An example of the decoder side intra mode derivation is template based intra mode prediction. Embodiments of the video processing methods receive input data associated with a current block, determine a coarse grain intra prediction mode for the current block, apply decoder side intra mode derivation to refine the coarse grain intra prediction mode to generate a refined mode, perform intra prediction for the current block based on the refine mode, and encode or decode the current block. The coarse grain intra prediction mode is signaled explicitly in the video bitstream. The decoder side intra mode derivation evaluates a number of intra prediction modes associated with the coarse grain intra prediction mode, and selects one intra prediction mode among the evaluated modes as the refined mode. The decoder side intra mode derivation selects the refined mode for the current block without referencing original samples of the current block. When template based intra mode prediction is used to select the refined mode, a difference between reconstructed samples and prediction samples of a template around the current block is calculated for each intra prediction mode under evaluation, and the refined mode is selected to have a minimum difference.

In some embodiments, the coarse grain intra prediction mode is explicitly signaled using a Most Probable Mode (MPM) flag followed by an MPM index or a remaining mode index. The decoder side intra mode detivation is adaptively applied according to a refine flag signaled in the video bitstream according to an embodiment. The decoder side intra mode derivation is applied to refine the coarse grain intra prediction and the refined mode is used to perform intra prediction if the refine flag indicates refinement, otherwise, the coarse grain intra prediction mode is used to perform intra prediction if the refine flag indicates no refinement. One embodiment of the adaptive decoder side intra mode derivation only signals the refine flag when the coarse grain intra prediction mode is an angular mode. Another embodiment always applies the decoder side intra mode detivation to refine the coarse grain intra prediction mode when the coarse grain intra prediction mode is an angular mode without signaling the refine flag.

Some variations of the embodiments fix the number of intra prediction modes associated with the coarse grain intra prediction mode under evaluation; some other embodiments adaptively determine the number of intra prediction modes under evaluation by signaling a syntax element in a slice level, picture level, or sequence level.

The coarse grain intra prediction mode is referenced as the intra prediction mode of the current block by at least one of intra mode dependent tool such as MPM derivation, coefficient scan, EMT, NSST, and sign hiding according to some embodiments of the present invention.

In some embodiments, the decoder side intra mode derivation is applied to refine the coarse grain intra prediction mode only when a block size of the current block satisfied a preset requirement. For example, template based intra mode prediction is only applied to refine the coarse grain intra prediction mode when the block size is greater than a predefined size.

Available modes for coding the current block can be classified into regions according to one embodiment, where the coarse grain intra prediction mode represents a selected region for the current block, and the decoder side intra mode derivation is applied to refine the coarse grain intra prediction by evaluating all modes in the selected region.

Aspects of the disclosure further provide a non-transitory computer readable medium storing program instructions for causing a processing circuit of an apparatus to perform video coding process with decoder side intra mode derivation. An embodiment of the video coding processing references a pseudo mode when processing a current block coded using the decoder side intra mode derivation by an intra mode dependent tool. Another embodiment of the video coding processing refines an explicitly signaled coarse grain intra prediction mode using the decoder side intra mode derivation. Other aspects and features of the invention will become apparent to those with ordinary skill in the art upon review of the following descriptions of specific embodiments.

### BRIEF DESCRIPTION OF THE DRAWINGS

Various embodiments of this disclosure that are proposed as examples will be described in detail with reference to the following figures, wherein:

FIG. 1 illustrates 33 angular Intra prediction modes supported in the HVEC standard.

FIG. 2 demonstrates reference samples involved in an intra smoothing filter for a current block coded using intra prediction.

FIG. 3 illustrates 65 angular Intra prediction modes including original 33 angular Intra prediction modes of HEVC and 32 newly added directions.

FIG. 4 illustrates template reference pixels used to generate prediction samples for the templates around a current block coded according to the decoder side intra mode derivation (DIMD) method.

FIG. 5A illustrates an exemplary block partitioning structure according to a Quad-Tree-Binary-Tree (QTBT) partitioning method.

FIG. 5B illustrates a coding tree structure corresponding to the block partitioning structure of FIG. 5A.

FIG. 6 illustrates a truncated template around a current block coded in the template based intra mode prediction method according to an embodiment of the present invention.

FIG. 7 is a flowchart illustrating an exemplary video data processing method according to an embodiment of the present invention.

FIG. 8 is a flowchart illustrating an exemplary video data processing method according to another embodiment of the present invention.

FIG. 9 illustrates an exemplary system block diagram for a video encoder incorporating t video data processing method according to embodiments of the present invention.

FIG. 10 illustrates an exemplary system block diagram for a video decoder incorporating the video data processing method according to embodiments of the present invention.

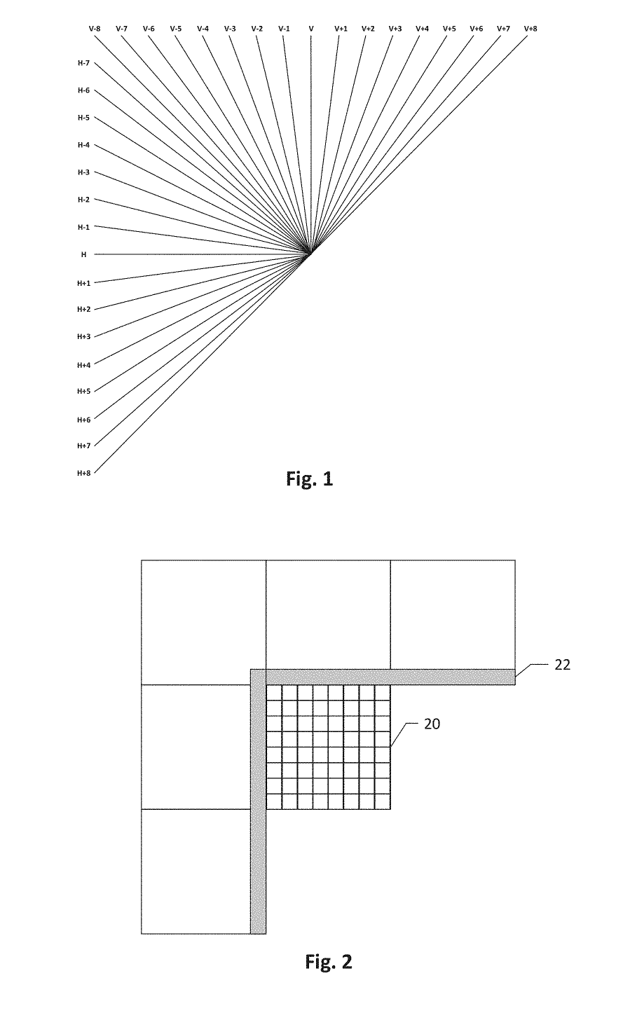

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention.

Reference throughout this specification to “an embodiment”, “some embodiments”, or similar language means that a particular feature, structure, or characteristic described in connection with the embodiments may be included in at least one embodiment of the present invention. Thus, appearances of the phrases “in an embodiment” or “in some embodiments” in various places throughout this specification are not necessarily all referring to the same embodiment, these embodiments can be implemented individually or in conjunction with one or more other embodiments. Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention.

The Decoder side intra Mode Derivation (DIMD) method reduces the overhead of intra prediction mode signaling, instead of signaling the intra prediction mode of a current block explicitly, both the encoder and decoder are able to derive the same intra prediction mode from neighboring reconstructed samples of the current block by using an identical deriving process. The decoder side intra mode derivation is an intra mode derivation method that determines the intra prediction mode of a current block without referencing original samples of the current block. An example of the DIMD method is template based intra mode prediction, which selects one intra prediction mode among a number of intra prediction modes by template matching. The intra prediction mode having a minimum difference between reconstructed samples and prediction samples of a template around the current block is selected by the DIMD method. The intra prediction mode derived by the DIMD method is used as the intra prediction mode when the current block is a 2N×2N Coding Unit (CU) when a corresponding CU-level DIMD flag is turned on. For N×N blocks, the intra prediction mode derived by the DIMD method is used to replace one Most Probable Mode (MPM) in the existing MPM set. For decoding a DIMD coded block, the intra prediction mode can only be determined after corresponding neighboring samples are reconstructed. However, in the parsing stage of the decoding process, parsing of some syntax elements and processing video data may depend on the intra prediction mode of the current block or neighboring block. For example, significant flags of coefficients are decoded according to a coefficient scan order, where different coefficient scan orders, including vertical scan, horizontal scan and diagonal scan, are applied to different intra prediction modes according to the block size. Different coefficient scan orders use different contexts for parsing the significant flags. In the HEVC standard, vertical scan is used to scan 4×4 and 8×8 Transform Units (TUs) when the intra prediction mode is within modes 6 to 14, horizontal scan is used to scan 4×4 and 8×8 TUs when the intra prediction mode is within modes 22 to 30, otherwise diagonal scan is used in coefficient scan. Before parsing coefficients of a current TU in a DIMD coded block, corresponding neighboring samples of the DIMD coded block need to be reconstructed to allow the decoder to derive the intra prediction mode.

The Residual Differential Pulse-Code Modulation (RDPCM) adopted in HEVC-RExt determines whether sign hiding is applied or not according to the intra prediction mode of a current TU. There are three RDPCM modes: RDPCM_OFF mode, RDPCM_HOR mode, and RDPCM_VER mode. The RDPCM is a sequence level enabling tool, and when RDPCM_HOR mode or RDPCM_VER mode is selected and transform skip mode is applied, sign hiding is disabled. The RDPCM mode for an inter prediction coded CU is signaled explicitly while the RDPCM mode for an intra prediction coded CU is inferred implicitly. RDPCM_HOR mode is inferred for intra prediction coded CUs with a horizontal intra prediction mode, RDPCM_VER mode is inferred for intra prediction coded CUs with a vertical intra prediction mode, and RDPCM_OFF mode is inferred for intra prediction coded CUs with other intra prediction modes.

The Intra prediction mode of a current Prediction Unit (PU) derived by the DIMD method also affects the MPM derivation of neighboring blocks. The parsing and reconstruction cannot be separated into two stages when DIMD is enabled as parsing of a current block depending on reconstruction of neighboring samples of the current block. Beside the parsing issues caused by the DIMD method, some decoding processes also depend on the intra prediction mode of the current PU or the current TU. For example the Enhanced Multiple Transform (EMT), Non-Separable Second Transform (NSST), and Reference Sample Adaptive Filter (RSAF) all have different decoding behaviors for different intra prediction modes.

In EMT, for each intra prediction mode, two different transforms can be selected for column transform and row transform. Two flags are signaled for selecting the column transform and row transform. For an intra prediction coded TU, transform parsing of NSST is intra prediction mode dependent, for example, two transforms are applied for TUs coded in DC or Planar mode, and three transforms are applied for TUs coded in angular modes. In another example, DC and Planar mode have three candidate transforms and other modes have four candidate transforms. The truncated unary code is used to signal the transform indices, up to 2 bins are signaled for DC or Planar mode, and up to 3 bins are signaled for any angular mode.

Replace with a Pseudo Mode in the Parsing Stage

In some embodiments of the present invention, a pseudo mode is referenced in the parsing stage when a current block is coded according to the intra prediction mode derived by Decoder side Intra Mode Derivation (DIMD). The DIMD determines an intra prediction mode for a current block without using original samples of the current block. Encoders and decoders derive the intra prediction mode according to the same deriving process, so signaling of the intra prediction modes derived by DIMD from encoders to decoders may be omitted. In one example, the DIMD can be template based intra mode prediction. The template based intra mode prediction determines one intra prediction mode according to a difference between reconstructed samples and prediction samples of a template around the current block. The intra prediction mode with the smallest difference is selected as the actual intra prediction mode for coding the current block. The current block may be a Coding Unit (CU), Prediction Unit (PU), or a Transform Unit (TU). This pseudo mode can be referenced by neighboring blocks of the current block in the parsing stage or can be referenced by one or more intra mode dependent tools. The pseudo mode is either a predefined mode known by both the encoders and the decoders or a derived mode derived by a predefined method known by the encoders and decoders. Some examples of the pseudo mode used to replace the actual intra prediction mode derived by the DIMD in the parsing stage are DC mode, Planar mode, vertical mode, horizontal mode, diagonal mode, and a derived mode. An embodiment of the derived mode is derived from one or more neighboring intra prediction modes. Another embodiment of the derived mode is a most probable mode (MPM) candidate in a MPM set derived for the current block, for example the first MPM candidate in the MPM set. The parsing issue may be solved by setting the intra prediction mode of a block coded by DIMD as the pseudo mode because this pseudo mode is independent to the intra prediction mode derived by the DIMD. In the parsing stage, the pseudo mode may be used to determine one or more of the coefficient scan order, RDPCM direction, sign hiding, and MPM derivation for a neighboring block when processing a block coded by DIMD.

The following examples assume the pseudo mode for replacing the actual intra prediction mode derived by DIMD is DC mode. An example of using the pseudo mode to derive the coefficient scan order for a current TU coded using the DIMD method always use diagonal scan for DIMD coded blocks. The DIMD method can be template based intra mode prediction in this example. In another example, the DC mode is inserted in the MPM set for a current block if a neighboring block of the current block is coded using DIMD. In another example, when RDPCM is enabled in a current sequence, sign hiding is disabled for DIMD coded blocks in the current sequence when transform skip mode is used. In yet another example, the decoder always use two transforms NSST when the current block is DIMD coded. According to this embodiment, the DC mode is used for all DIMD coded blocks while actual intra prediction modes for all non-DIMD intra coded blocks are used in the parsing stage for determining the coefficient scan order, RDPCM direction, sign hiding, and MPM set derivation.

In cases when the actual intra prediction mode derived by DIMD for some blocks such as N×N partitions, is inserted in a first candidate in the MPM set, there is no signaling to indicate the usage of DIMD in the parsing stage. In order to resolve the parsing issue caused by DIMD for these blocks, template based intra prediction is disabled for these blocks, such as N×N PUs and N×N CUs according to an embodiment. In another embodiment, an explicit DIMD flag is signaled for each N×N PU or N×N CU as it does for 2N×2N PU or 2N×2N CU to indicate whether DIMD is used.

Embodiments of the present invention replace an actual intra prediction mode derived by DIMD with a pseudo mode in the parsing stage when processing a current block coded using DIMD, however, the actual intra prediction mode derived by DIMD is used in one or snore of other coding tools such as intra prediction, transform, EMT, NSST, and RSAF. The actual intra prediction modes derived by non-DIMD are used for intra prediction, transform, EMT, NSST, and RSAF as well as in the parsing stage when processing blocks coded using non-DIMD. Non-DIMD requires original samples of a current block to derive an intra prediction mode for the current block. An example of the non-DIMD is a conventional intra prediction method defined in the HEVC standard or the H.264/AVC standard.

Replace with a Pseudo Mode when a Reference Block is Coded Using DIMD

Some embodiments of the present invention replace an actual intra prediction mode with a pseudo mode when referencing a DIMD coded block, where the pseudo mode may be set to DC mode, Planar mode, Vertical mode, Horizontal mode, Diagonal mode, or a derived mode. The derived mode may be derived from one or more neighboring intra prediction modes or one MPM candidate in the MPM set, for example, a first candidate in the MPM set. In the parsing stage, the pseudo mode is referenced by a current block having a neighboring block coded using DIMD, and if the current block is also coded using DIMD, the intra prediction mode of the current block is also assumed to be the pseudo mode in the parsing stage. The actual intra prediction mode derived by DIMD is used to predict the current block in intra prediction to generate an intra predictor.

In another embodiment, when a neighboring block of a current intra coded block is coded using a DIMD method, the intra prediction mode of that neighboring DIMD coded block is marked as unavailable and is not included in the MPM set for the current intra coded block. The DIMD method can be template based intra mode prediction. For example, if intra prediction modes of all neighboring blocks of a current intra coded block are all marked as unavailable, the MPM set of the current intra coded block is consisting of predefined intra prediction modes such as {DC, Planar, Vertical} the fixed number of MPMs in the MPM set is 3, or {DC, Planar, Vertical, Horizontal, Diagonal} if the fixed number of MPMs in the MPM set is 5.

For some blocks such as N×N partitions, the intra prediction mode derived by DIMD is inserted in a first candidate of the MPM set. In order to solve the parsing issue, DIMD is disabled for these blocks, or an explicit flag is signaled for each of these blocks to indicate the usage of DIMD, and a pseudo mode is referenced by neighboring blocks of a current block coded using DIMD.

Replace with a Pseudo Mode in the Reconstruction Stage

In an embodiment, a pseudo mode is used as a decoded intra prediction mode in the reconstruction stage if a current block is coded by DIMD. Examples of the pseudo mode include DC mode, Planar mode, vertical mode, horizontal mode, diagonal mode, or a derived mode, where the derived mode may be one MPM in the MPM set such as a first candidate in the set. One or more of the intra mode dependent tools applied in the reconstruction stage of a current block uses the pseudo mode instead of the actual intra prediction mode derived by DIMD if the current block is a DIMD coded block. The intra mode dependent tools include transforms, Enhanced Multiple Transform (EMT), Non-Separable Second Transform (NSST), and Reference Sample Adaptive Filter (RSAF). The same pseudo mode may be used in the parsing stage as well as the reconstruction stage for the DIMD coded blocks according to an embodiment. Different pseudo modes may be used in the parsing stage and at least one intra mode dependent tool in the reconstruction stage according to another embodiment. The actual intra prediction mode derived by DIMD is used to generate the intra predictor for the current block in intra prediction.

Unified Parsing for Intra Mode Dependent Coding Tools

Some intra mode dependent coding tools such as EMT and NSST were proposed in JEM. Two flags are required for every intra coded block so there is no parsing issue for EMT. However, different intra prediction modes need to parse different amount of bins for NSST which causes the parsing issue. Two modifications could be made to solve the parsing issue caused by the intra mode dependent coding tools. First, a predefined coefficient scan order is used in coefficient coding for all blocks, where the predefined coefficient scan order is diagonal scan, vertical scan, horizontal scan, or zig-zag scan. Second, the codeword-length of NSST is unified. The same syntaxes and context formation are applied for all kinds of intra prediction modes when decoding EMT and NSST syntax elements. For example, two transforms are selected for all Ultra modes for EMT, and all intra prediction modes have two or three NSST candidate transforms. In another example, all intra prediction modes have four NSST candidate transforms. For RDPCM, sign hiding is either always applied or always not applied. For example, sign hiding is disabled for intra prediction coded blocks of a current sequence when transform skip mode is used and RDPCM is enabled in the current sequence. By unifying parsing process for all intra mode dependent coding tools, the decoder does not need to determine actual intra prediction modes of all intra coded blocks in the parsing stage. The same pseudo mode is used to replace actual intra prediction modes derived by DIMD and non-DIMD. The pseudo mode is referenced by one or more intra mode dependent tools for all intra prediction coded blocks in syntax signaling or parsing. The intra mode dependent tools include intra-mode-dependent coefficient scan, MPM derivation, RDPCM, NSST, EMT, and RSAF, The actual intra prediction modes derived by DIMD or non-DIMD are used to generate intra predictors, DIMD determines the actual intra prediction modes without referencing original samples whereas non-DIMD determines the actual intra prediction modes by referencing the original samples, A Decoder determines the actual intra prediction modes derived by DIMD using the same deriving process as the encoder, whereas the decoder determines the actual intra prediction modes derived by non-DIMD according to one or more syntax elements signaling in the video bitstream.

In a variation of the embodiment, the transform coefficients can be rearranged before entropy encoding at an encoder side and rearranged back after parsing at a decoder side. In this embodiment, the predefined coefficient scan order corresponding to the pseudo mode is used for every intra prediction mode in the parsing stage. In the encoder side, the transform coefficients are rearranged from one coefficient scan order to another coefficient scan order after transform and quantization, for example, from vertical scan or horizontal scan to diagonal scan. The encoder reads out the transform coefficients of a current TU by an original coefficient scan order, such as vertical scan or horizontal scan, and stores into another coefficient buffer by a predefined coefficient scan order, such as diagonal scan. The coefficient buffer for transform coefficient rearranging is used for entropy encoding with diagonal scan. In the decoder side, the predefined coefficient scan order corresponding to the pseudo mode is used for parsing the transform coefficients. The parsed transform coefficients are rearranged back from the predefined coefficient scan order to the original coefficient scan order before inverse quantization and inverse transform.

In one embodiment, the above described unified parsing for the intra mode dependent tools are used only when DIMD is enabled; original parsing and intra mode dependent tools reference the actual intra prediction modes when DIMD is disabled. The DIMD method can be template based intra mode prediction determines intra prediction modes by template matching. For example, a pseudo mode is used to derive one or more of a coefficient scan order, sign hiding, and RDPCM direction for both blocks coded in DIMD and non-DIMD when DIMD is enabled, in another example, four NSST candidate transforms are always used for all intra prediction coded blocks when DIMD is enabled. When DIMD is disabled, the actual intra prediction mode derived by non-DIMD is referenced by intra mode dependent tools such as intra-mode-dependent coefficient scan, MPM derivation and RDPCM. DIMD can be enabled in Coding Tree Unit (CTU), slice, picture, or sequence level.

DIMD Mode is Treated as One of the Intra Prediction Modes

In some embodiments, the intra prediction mode derived by DIMD, is treated as one of the intra prediction modes. The DIMD method can be template based intra mode prediction which determines the intra prediction mode according to a difference between reconstructed samples and prediction samples of a template. Blocks coded using DIMD are referred as blocks coded in DIMD mode. DIMD mode is assigned with a predefined intra prediction mode index, for example, intra prediction mode index 0 or 35 represents DIMD mode, while each of the other intra prediction mode indices represents one of the angular modes, DC mode, or Planar mode. The same intra prediction mode signaling is applied to all DIMD coded blocks and non-DIMD coded blocks, for example, by using an MPM flag follow by an MPM index or remaining mode index. By treating MID mode as one intra prediction mode, DIMD mode is like one of the angular modes, DC mode, and Planar mode; and DIMD mode can be added to the MPM set to be referenced by neighboring blocks of a DIMD coded block. When a block selects DIMD mode, one pre-defined coefficient scan is used, for example, diagonal scan is selected for processing DIMD coded blocks. DIMD mode may correspond to an alternative pre-defined coefficient scan orders such as zig-zag scan, vertical scan, or horizontal scan. The transform of a pseudo mode or coding process of a pseudo mode is used when an intra mode dependent transform or intra mode dependent coding tool is applied to DIMD coded blocks. For example the pseudo mode is DC mode. DIMD mode is always inserted in the MPM set according to one embodiment, and if DIMD mode is not in the MPM set, one of the MPM candidates in the IPM set is replaced by DIMD mode. For example, DIMD mode is always put into the MPM set at a fixed position, such as position 0 or 1, or DIMD mode is put into the MPM set no-larger than a predefined position, such as the MPM index of DIMD mode is small than N.

Coarse Grain Intra Prediction Mode with DIMD Refinement

A coarse grain intra prediction mode of a current block is first determined and the corresponding mode index is explicitly signaled. The mode index may be signaled according to a conventional intra prediction mode signaling method such as using an MPM flag followed by an MPM index or a remaining mode index. A DIMD method is applied to refine the coarse grain intra prediction mode. The DIMD method refines the coarse grain intra prediction mode of a current block without referencing original samples of the current block. For example, the DIMD method can be template based intra mode prediction. In one embodiment, a MID refine flag is signaled to decide whether the DIMD method is applied to refine the coarse grain intra prediction mode. The coarse grain intra prediction mode is used in intra prediction when the DIMD refine flag indicates no refinement. If the DIMD method is applied to refine the coarse grain intra prediction mode, intra prediction modes associated with the coarse grain intra prediction mode are evaluated by the DIMD method. For example, the intra prediction modes with mode indices of +N to −N of the coarse grain intra prediction mode index are evaluated by template matching of the DIMD method. The number of intra prediction modes under evaluation can be predefined by fixing the value of N, or adaptively determined by signaling the value of N in a syntax element in a slice level, picture level, or sequence level. For example, the template based intra mode prediction selects one intra prediction mode for a current block with a lowest cost among the intra prediction modes under evaluation as a refined mode. The lowest cost may be a smallest difference between reconstructed samples and prediction samples of a template around the current block. The refined mode is used as the intra prediction mode of the current block. In one embodiment, at least one of MPM derivation, intra-mode-dependent coefficient scan, NSST, EMT, and sign-hiding in RDPCM refers the intra prediction mode of the current block as the explicitly signaled coarse grain intra prediction mode instead of the refined mode. An embodiment of signaling a DIMD refine flag for DIMD refinement selectively signals the DIMD refine flag according to the coarse grain intra prediction mode, for example, the DIMD refine flag is only signaled when the coarse grain intra prediction mode is an angular mode, so DIMD refine flag is omitted when the coarse grain intra prediction mode is DC or Planar mode. In some other embodiments, the DIMD refine flag is not signaled, which implies DIMD is always applied to refine the coarse grain intra prediction mode. An example of the embodiments applies DIMD when the coarse grain intra prediction mode is an angular mode, and another example of the embodiments applies DIMD to all intra prediction modes including angular modes, DC mode, and Planar mode.

In one example, the coarse grain intra prediction mode is selected from the 35 modes defined in the HEVC standard, and a mode index of the selected coarse grain intra prediction mode is explicitly transmitted. The coarse grain intra prediction mode is refined into a fine grain intra prediction mode according to 65 angular modes as shown in FIG. 3 or 129 angular modes which further split the angle of each mode in the 65 angular modes. In one embodiment, when the 65 angular modes are used as the angular resolution in DID, a coarse grain intra prediction angular mode is first mapped to one of the 65 angular modes, and then two neighboring modes, i.e. +1 and −1 intra prediction modes of the mapped mode together with the mapped mode are evaluated using DIMD. The intra prediction mode with a lowest cost or smallest difference among the three modes is selected as the refined mode. Another embodiment uses the 129 angular modes as the angular resolution in DINED, four neighboring modes, i.e. +2 and −2 intra prediction modes, or six neighboring modes, i.e. +3 and −3 intra prediction modes of the mapped mode together with the mapped mode are evaluated using DIMD. The intra prediction mode with a lowest cost or smallest difference among the five or seven modes is selected as the refined mode. In one embodiment, if DC or Planar mode is selected as the coarse grain intra prediction mode, DIMD is performed to evaluate DC, Planar, vertical, horizontal, and diagonal modes. In another example, DC and Planar modes are combined as one non-angular coarse grain intra prediction mode, and when this non-angular coarse grain intra prediction mode is determined, DIMD is used to decide whether the refined mode is DC or Planar mode.

In an embodiment, DIMD for mode refinement is applied to all block sizes, while in some other embodiments, DIMD is applied only to certain block sizes to reduce the signaling overhead. DIMD is only applied to refine the coarse grain intra prediction mode for intra coded blocks with a block size satisfying a preset requirement. DIMD is either applied to all the intra prediction coded blocks satisfying the preset requirement or adaptively applied to the intra prediction coded blocks satisfying the preset requirement according to a DIMD refine flag. For example, DIMD refinement is only used for intra prediction coded blocks with a block area greater than a predefined size MIN_BLOCK_SIZE, where the block area in this example is calculated by multiplying the width and height of the intra prediction coded block, width*height>MIN_BLOCK_SIZE. A DIMD refine flag may be used to signal whether DIMD refinement is applied to a current block if the block area of the current block is greater than the predefined size. If the DIMD refine flag is not used, all intra prediction coded blocks larger than the predefined size are subject to DIMD refinement. For intra prediction coded blocks smaller than or equal to the predefined size, DIMD refinement is not applied and the DIMD refine flag is not needed. The predefined size MIN_BLOCK_SIZE is either predefined or signaled by a syntax element in a slice level, picture level, or sequence level. In another example, DIMD refinement is only applied to intra prediction coded blocks with a block area greater than a first predefined size and smaller than a second predefined size, width*height>MIN_BLOCK_SIZE; and width*height<MAX_BLOCK_SIZE. A DIMD refine flag may be signaled for every intra prediction coded block with a block area greater than the first predefined size and smaller than the second predefined size. For intra prediction coded blocks smaller than the first predefined size or greater than the second predefined size, template based intra prediction refinement is not applied to refine the explicitly signaled coarse grain intra prediction mode. Similarly, the first predefined size MIN_BLOCK_SIZE and the second predefined size MAX_BLOCK_SIZE are either predefined or signaled by syntax elements in a slice level, picture level, or sequence level.

In an alternative embodiment, instead of calculating the block area of each intra prediction coded block, a sum of width and height of the intra prediction coded block is calculated and compared with a predefined size. For example, DIMD refinement is only applied for intra prediction coded blocks with a sum of width and height greater than a predefined size MIN_BLOCK_SIZE, width+height>MIN_BLOCK_SIZE. A DIMD flag may be signaled for intra prediction coded blocks having a sum of width and height greater than the predefined size. For intra prediction coded blocks with a sum of width and height less than or equal to the predefined size, DIMD refinement is not applied. The predefined size MIN_BLOCK_SIZE can be either predefined or signaled by a syntax element in a slice level, picture level, or sequence level. In another example, the preset requirement for applying DIMD refinement is satisfied when a sum of width and height of the intra prediction coded block is greater than a first predefined size MIN_BLOCK_SIZE and smaller than a second predefined size MAX_BLOCK_SIZE, width+height>MIN_BLOCK_SIZE and width+height<MAX_BLOCK_SIZE. A DIMD refine flag is signaled for the intra coded blocks with a sum of width and height greater than the first predefined size and smaller than the second predefined size. For intra prediction coded blocks with a sum of width and height smaller than or equal to the first predefined size or larger than or equal to the second predefined size, DIMD refinement is not applied. The first and second predefined size may be predefined or signaled by syntax elements in a slice level, picture level, or sequence level.

The preset requirement in another embodiment separately checks the length of a width and height of the intra prediction coded block, for example, DIMD refinement is only applied to intra prediction coded blocks with a width greater than a predefined size and a height also greater than the predefined size. In another example, DM) refinement is only applied to intra prediction coded blocks with both a width greater than a first predefined size and smaller than a second predefined size and a height greater than the first predefined size and smaller than the second predefined size. The predefined size, first predefined size, second predefined size, width and height in the previously described embodiments may be signaled with LOG 2.

Coarse Region with DIMD Refinement

In some embodiments of applying DIMD refinement, available modes are classified into several regions, and an index is used to signal a selected region. DIMD refinement is applied to the selected region by performing template matching search over all angular modes in the selected region. The best mode with a lowest cost or smallest difference is selected to be the refined mode. A special region containing DC and Planar modes may also be defined for performing DIMD refinement. The index used to signal the selected region may correspond to a coarse grain intra prediction mode, which is used to represent all modes in the selected region. In order to solve the parsing issue caused by one or more intra mode dependent tools, a coarse grain intra prediction mode representing modes in each of the regions is referred as the intra prediction mode in the parsing stage. For an intra prediction coded block with an index indicating a selected region, a coarse grain intra prediction mode corresponding to the selected region is used to determine parameters of the intra prediction mode dependent tools such as the coefficient scan order and NSST index. When a current intra prediction coded block is referencing a neighboring block for constructing a MPM set, the coarse grain intra prediction mode corresponds to the region selected by the neighboring block is used as the intra prediction mode for this neighboring block.

In one example, angular modes are divided into four regions, one region includes angular modes close to the horizontal direction, one region includes angular modes close to the vertical direction, one region includes angular modes close to −45 degree direction, and the last region includes angular modes close to diagonal 45 degree direction or diagonal 22.5 degree direction. In this example, the coarse grain intra prediction mode of a region is set to be a center mode of this region if all modes in the region are angular and continuous. Note that diagonal 45 degree direction and diagonal 225 degree direction are considered as next to each other so these two directions can be regarded as continuous if a region covers both of these two modes. The coarse grain intra prediction mode for each region is be predefined and known by both the encoders and decoders.

No Successive Blocks Coded Using DIMD

Some embodiments of DIMD have one constraint, for example, if a block is coded using MID, following N blocks cannot be coded using DINED. This constraint may be an encoder constraint or syntax constraint. An example of the syntax constraint is realized by removing the syntax related to the DENIED for the following N blocks of a DIMD coded block, where N is 2, 3, 4 or any integer. It is also possible to allow different values of N for different block sizes.

In another embodiment, a number of DIMD coded blocks in a Coding Tree Unit (CTU) is constrained, and in another embodiment, if none of the neighboring blocks of a current block are coded using DIMD, the current block can be coded using DIMD. In yet another embodiment, if all the neighboring blocks of a current block are coded using DIMD, the current block cannot select DIMD.

Using Actual Intra Prediction Modes in Different CTU or CTU-Row

The intra prediction mode in an upper CTU row are treated as DC mode according to the HEVC standard. An embodiment of video processing method with DIMD can reference the actual intra prediction modes in upper CTU or upper CTU-rows. For blocks coded using DIMD in upper CTU-rows or upper CTUs of a current CTU, the actual intra prediction modes derived by DIMD are used as the reference intra prediction modes for intra prediction coded blocks in the current CTU. The actual intra prediction mode derived by DIMD is referenced by blocks in a different CTU or CTU-row. For example, these actual intra prediction modes derived by the DIMD method are stored as one of the intra prediction modes. For DIMD coded blocks in the current CTU-row or in the current CTU, one or more of the following methods can be applied. A pseudo mode is used to replace the actual intra prediction mode in the parsing stage, a pseudo mode is used as the intra prediction mode referenced by other intra coded blocks in the current CTU-row or in the current CTU, and a pseudo mode is used to replace the actual intra prediction mode in transform, EMT, NSST, and RSAF. The actual intra prediction modes for blocks in the upper CTU or upper CTU-row can be referenced by blocks in the current CTU or CTU-row because the reconstruction process for blocks in the upper CTU or upper CTU-row should be completed when processing the current CTU or the current CTU-row.

Apply MAID to Maximum CU Size

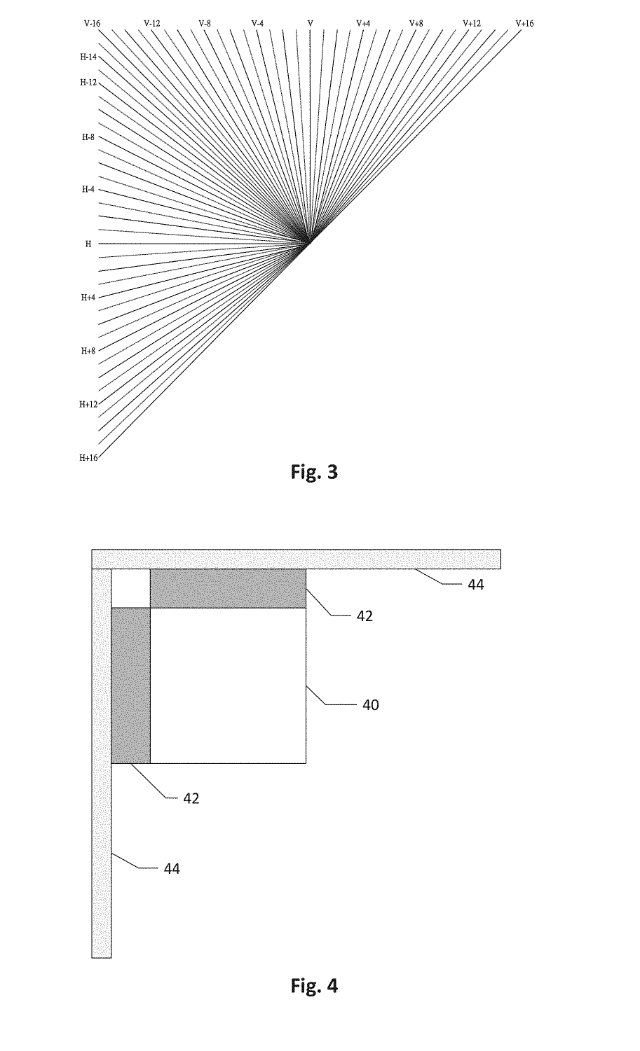

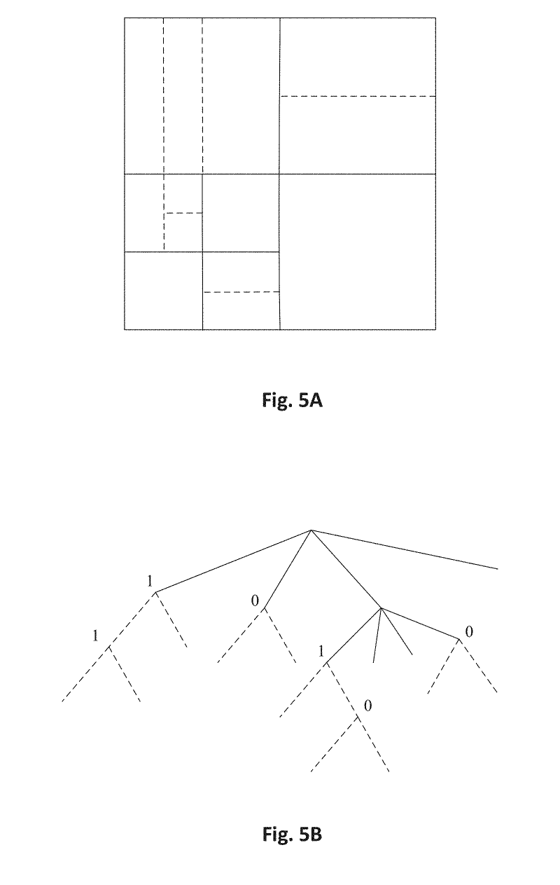

In JEM 2.0, the DIMD calculation is based on TU, where the maximum TU size is 64. Some of the intra prediction tools in JEM 2.0 such as deciding whether to apply the intra reference filtering is related to the size of the current block. Intra reference filtering is applied to the reference pixels if a mode difference is greater than a threshold. The mode difference is the minimum of a mode difference from horizontal mode and difference from vertical mode. The threshold is depending on the current CU size. Since the maximum CU size is greater than the maximum TU size in JEM, the region used to decide the threshold is TU width plus the defined template size, for example L+N in FIG. 4. The value of L is predefined value such as 1, 2, or 4, where L+N cannot exceed the maximum CU size. When the size of a CU is the maximum CU size and when the block size for a CU is equal to TU and PU, the region used to decide the threshold is maximum CU size plus the defined template size, which exceeds the threshold table. In order to solve this issue, three methods are proposed as following. In a first method, DAM is disabled for blocks with a CU size equal to the maximum CU size. A second method modifies a threshold table to support bigger lock sizes. Table 1 shows an exemplary threshold table used in JEM 2.0 which demonstrates the thresholds and corresponding block depths. Table 2 shows an exemplary threshold table after the modification. The maximum CU depth is 7, and the maximum CU size is 128 for QTBT structure. In the threshold table shown in FIG. 2, the maximum depth is set to 8,

TABLE 1

| Block width | Depth | threshold |
|---|---|---|
| 4 | 1 | 40 |
| 8 | 2 | 28 |
| 16 | 3 | 4 |
| 32 | 4 | 0 |
| 64 | 5 | 40 |
| 128 | 6 | 0 |
| 256 | 7 | 0 |

TABLE 2

| The smaller of block | | |
|---|---|---|
| width and height | Depth | threshold |
| =2 | 0 | 20 |
| >2 and <=4 | 1 | 40 |
| >4 and <=8 | 2 | 28 |
| >8 and <=16 | 3 | 4 |
| >16 and <=32 | 4 | 0 |
| >32 and <=64 | 5 | 40 |
| >64 and <=128 | 6 | 0 |
| >128 | 7 | 0 |

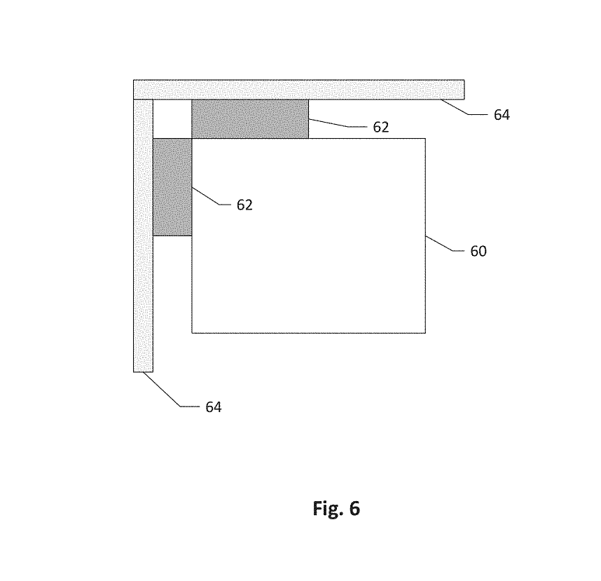

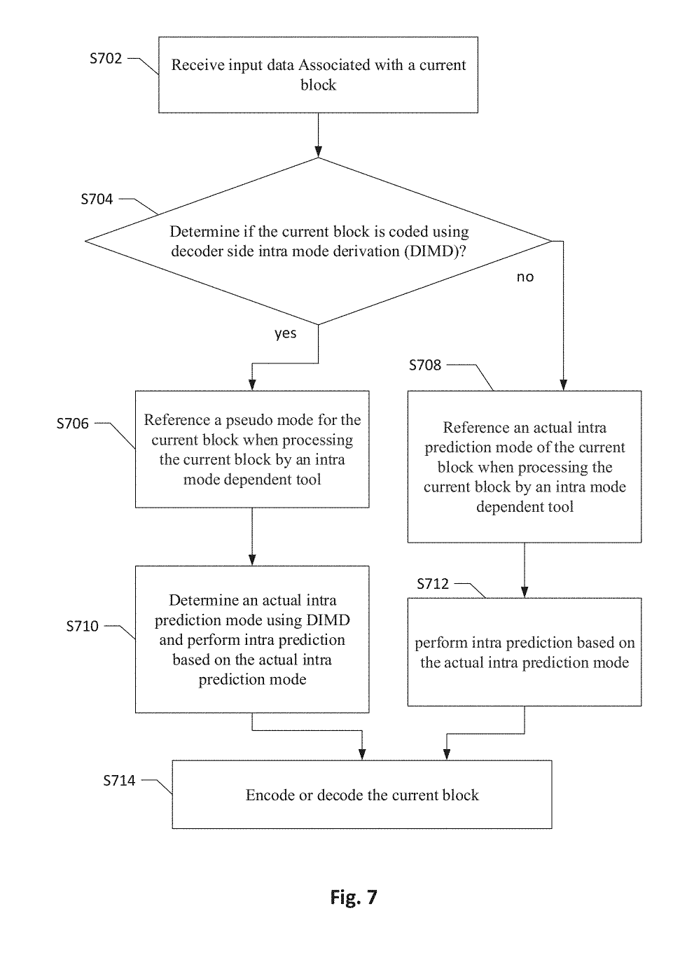

A third method truncates the template when performing DIMD using template based intra mode prediction. In one embodiment, for the template size exceeds the maximum CU size, the maximum CU size is used to derive the threshold. In another embodiment, all the blocks use half the length of a width and half the length of a height for the template length for the above and left of a DIMD coded block. A segment of template 62 above the DIMD coded block 60 has a size of width/2*L and a segment of template 62 on the left of the DIMD coded block 60 has a size of height/2 as shown in FIG. 6. Template reference pixels 64 are used to generate prediction samples for the template 62. In another embodiment, the template size is ¾ width and ¾ height for template pixel length in the above and left of the DIMD coded block, separately. In another embodiment, the template length can use other value smaller than the width and height of the DIMD coded block.

Parsing Issue and Pipeline Issue for Inverse Transform

The parsing issue of a block coded using DIMD with intra mode dependent coding tools may be solved by replacing an actual intra prediction mode derived by DIMD with a pseudo mode in the parsing stage or by unifying the parsing process of all intra coded blocks with respect to the intra mode dependent coding tools. However, the decoder still cannot process the blocks coded using DIMD by inverse transform (IT) with intra mode dependent coding tools such as EMT and NSST if the actual intra prediction mode is not yet determined. A general decoder pipeline separates the decoding processes into three pipeline stages, parsing, inverse quantization and inverse transform (IQ/IT), and reconstruction stages. In order to enable the intra mode dependent coding tools applied in IT, the decoder pipeline may be modified to combine IT with reconstruction, so the three pipeline stages becomes parsing, inverse quantization (IQ), and inverse transform plus reconstruction. Some embodiments of the present invention use a pseudo mode for blocks coded using DIMD in the parsing stage as well as the intra mode dependent coding tools for inverse transform such as EMT and NSST. The pseudo mode used in the parsing stage may be the same or different for the pseudo mode used for the inverse transform. Although the coding gain of the mode dependent transform for blocks coded using DIMD is lost according to this embodiment, the coding gain resulted by the mode dependent transform for other intra prediction coded blocks are reserved. In one embodiment, Planar mode is referenced by a current block if a neighboring block is coded using DIMD, diagonal scan is used to scan transform coefficients in blocks coded using DIMD, sign-hiding is disabled when the current block is coded using DIMD and transform skip mode is used, two transforms NSST are used for blocks coded using DIMD, and DC mode is used for EMT and NSST. In one embodiment, the pseudo mode method is used when DIMD is enabled, for example DIMD is enabled in the CTU, current slice, picture, or sequence level; else the original process is applied when DIMD is disabled.

FIG. 7 is a flow chart illustrating video data processing with DIMD according to embodiments of the present invention. In step S702, input data associated with a current block is received by an encoder or a decoder. The current block is determined to be coded using DIMD or non-DIMD in step S704, and if the current block is coded using DIMD, a pseudo mode is referenced by one or more intra mode dependent tools in step S706. DIMD determines an actual intra prediction mode for the current block without referencing actual samples in the current block in step S710. An example of DAM is template based intra mode prediction, and the template may contain one template portion above the current block and one template portion on the left of the current block. Prediction samples of the template for an intra prediction mode is obtained from template reference samples according to the intra prediction mode. The intra prediction mode with a smallest difference is selected as the actual intra prediction mode. In step 710, intra prediction is performed based on the actual intra prediction mode derived by DIMD. If the current block is coded using non-DIMD, an actual intra prediction mode of the current block is reference by one or more intra mode dependent tools in step S708. For example, the pseudo mode is used to derive a coefficient scan order and sign hiding if the current block is coded using DIMD, else the actual intra prediction mode is used to derive the coefficient scan order and sign hiding. In step S712, intra prediction is performed based on the actual intra prediction mode derived by non-DIMD. The encoder encodes the current block or the decoder decodes the current block in Step S714.

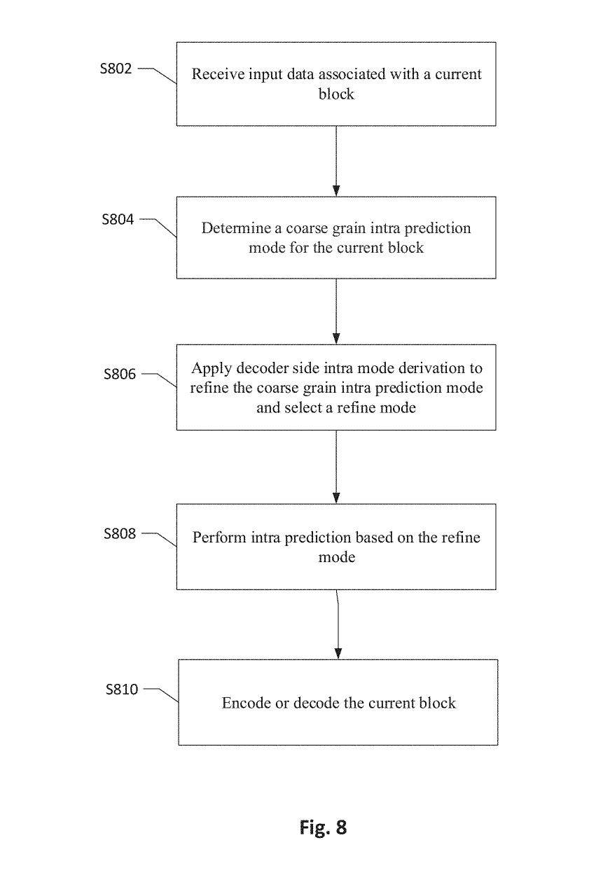

FIG. 8 is a flow chart illustrating an exemplary video data processing method according to another embodiment of the present invention. A video encoder receives input data associated with a current block of the video data or a video decoder receives input data associated with a current block from a video bitstream in step S802. A coarse grain intra prediction mode is determined for the current block in step S804, where the coarse grain intra prediction mode is signaled explicitly in the video bitstream. In step S806, DIMD is applied to the current block to refine the coarse grain intra prediction mode and select a refined mode. DIMD evaluates a number of intra prediction modes associated with the coarse grain intra prediction modes and select the refined mode according to the DIMD method. The intra prediction modes under evaluation include the coarse grain intra prediction mode and at least one other mode, for example the other modes are two angular modes closest to the coarse grain intra prediction mode. Intra prediction is performed based on the refined mode in step S808. The video encoder encodes the current block to generate the video bitstream or the video decoder decodes the current block to generate decoded video in step S810.

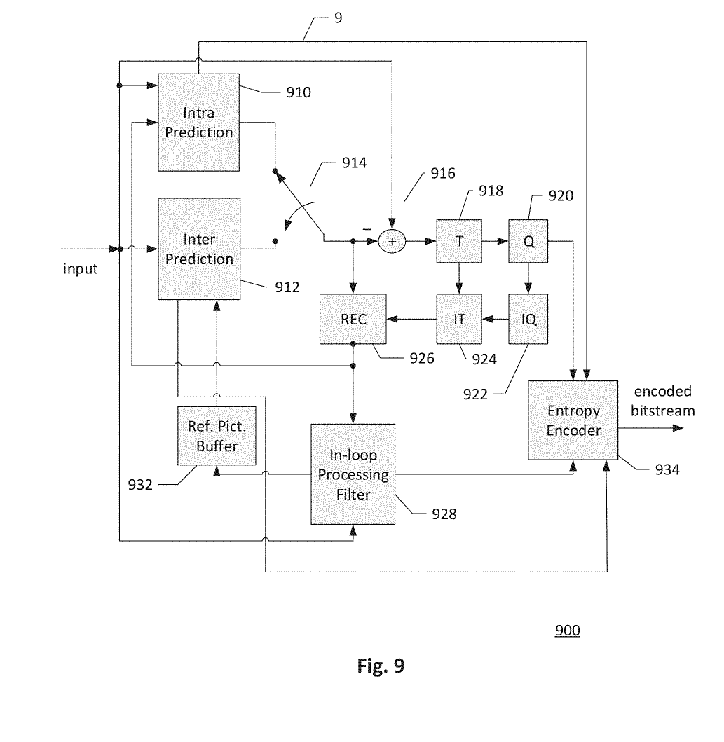

FIG. 9 illustrates an exemplary system block diagram for a Video Encoder 900 implementing embodiments of the present invention. Intra Prediction 910 provides intra predictors based on DIMD. DIMD selects one mode as an actual intra prediction mode for a current block according to a difference between reconstructed samples and prediction samples of a template around the current block. In some embodiment, a pseudo mode is used to replace the actual intra prediction when processing the current block by an intra mode dependent tool, such as using the pseudo mode to derive the coefficient scan order or sign hiding. In some other embodiments, DIMD is applied to refine a coarse grain intra prediction mode. Inter Prediction 912 performs motion estimation (ME) and motion compensation (MC) to provide predictors based on video data from other picture or pictures. Either Intra Prediction 910 or Inter Prediction 912 supplies the selected predictor to Adder 916 to form prediction errors, also called residues. The residues of the current block are further processed by Transformation (T) 918 followed by Quantization (Q) 920. The transformed and quantized residual signal is then encoded by Entropy Encoder 934 to form a video bitstream. The video bitstream is then packed with side information such as a flag indicating the usage of the DIMD or an index corresponding to the coarse grain intra prediction mode. The transformed and quantized residual signal of the current block is processed by inverse Quantization (IQ) and Inverse Transformation (IT) 24 to recover the prediction residues. As shown in FIG. 9, the residues are recovered by adding back to the selected predictor at Reconstruction (REC) 926 to produce reconstructed video data. The reconstructed video data may be stored in Reference Picture Buffer (Ref. Pict. Buffer) 932 and used for prediction of other pictures. The reconstructed video data from REC 926 may be subject to various impairments due to the encoding processing, consequently, In-loop Processing Filter 928 is applied to the reconstructed video data before storing in the Reference Picture Buffer 932 to further enhance picture quality. Syntax elements 9 corresponding to DIMD may be provided to Entropy Encoder 934 for incorporation into the video bitstream.

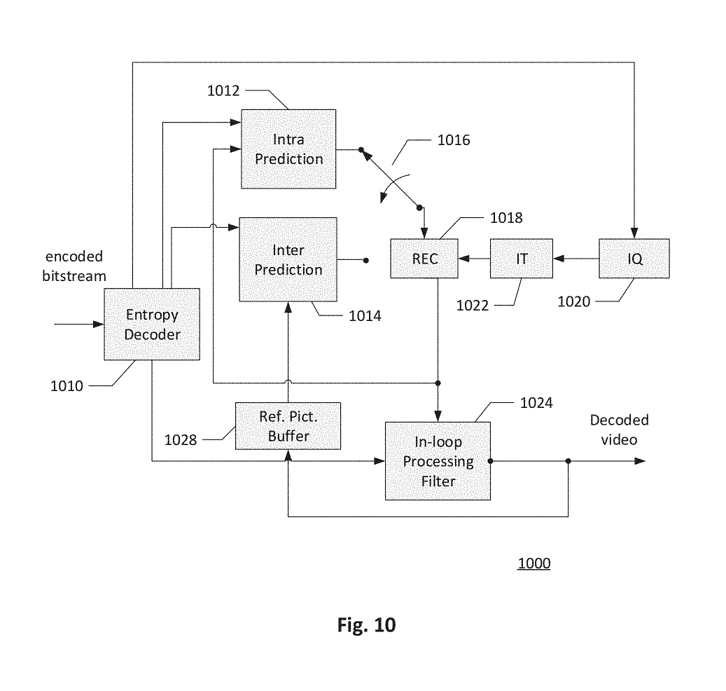

A corresponding Video Decoder 1000 for Video Encoder 900 of FIG. 9 is shown in FIG. 10. The video bitstream encoded by a video encoder is the input to Video Decoder 1000 and is decoded by Entropy Decoder 1010 to parse and recover the transformed and quantized residual signal and other system information. Entropy Decoder 1010 parses the current block according to a pseudo mode if the current block is coded in DIMD in one embodiment, and Entropy Decoder 1010 parses an index corresponding to a coarse grain intra prediction mode according to another embodiment. The decoding process of Decoder 1000 is similar to the reconstruction loop at Encoder 900, except Decoder 1000 only requires motion compensation prediction in inter Prediction 1014. Each block is decoded by either Intra Prediction 1012 or Inter Prediction 1014. Intra prediction 1012 applies DIMD in accordance with various embodiments of the present invention, for example, DIMD is applied to refine the coarse grain intra prediction mode. Switch 1016 selects an intra predictor from Intra Prediction 1012 or Inter predictor from Inter Prediction 1014 according to decoded mode information. The transformed and quantized residual signal associated with each block is recovered by Inverse Quantization (IQ) 1020 and Inverse Transformation (IT) 1022. The recovered residual signal is reconstructed by adding back the predictor in REC 1018 to produce reconstructed video. The reconstructed video is further processed by In-loop Processing Filter 1024 to generate final decoded video. If the current decoded picture is a reference picture, the reconstructed video of the currently decoded picture is also stored in Ref. Pict. Buffer 1028 for later pictures in decoding order.

Various components of Video Encoder 900 and Video Decoder 1000 in FIG. 9 and FIG. 10 may be implemented by hardware components, one or more processors configured to execute program instructions stored in a memory, or a combination of hardware and processor. For example, a processor executes program instructions to control receiving of input data associated with a current picture. The processor is equipped with a single or multiple processing cores. In some examples, the processor executes program instructions to perform functions in some components in Encoder 900 and Decoder 1000, and the memory electrically coupled with the processor is used to store the program instructions, information corresponding to the reconstructed images of blocks, and/or intermediate data during the encoding or decoding process. The memory in some embodiment includes a non-transitory computer readable medium, such as a semiconductor or solid-state memory, a random access memory (RAM), a read-only memory (ROM), a hard disk, an optical disk, or other suitable storage medium. The memory may also be a combination of two or more of the non-transitory computer readable medium listed above. As shown in FIGS. 9 and 10, Encoder 900 and Decoder 1000 may be implemented in the same electronic device, so various functional components of Encoder 900 and Decoder 1000 may be shared or reused if implemented in the same electronic device.

Embodiments of the video data processing method with DIMD for video coding system may be implemented in a circuit integrated into a video compression chip or program code integrated into video compression software to perform the processing described above. For examples, determining of a current mode set for the current block may be realized in program code to be executed on a computer processor, a Digital Signal Processor (DSP), a microprocessor, or field programmable gate array (FPGA). These processors can be configured to perform particular tasks according to the invention, by executing machine-readable software code or firmware code that defines the particular methods embodied by the invention. The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing video data in a video coding system, comprising:
receiving input data associated with a current block of the video data;
determining an actual intra prediction mode for the current block by performing decoder side intra mode derivation;
performing intra prediction for the current block based on the actual intra prediction mode;
replacing the actual intra prediction mode determined by the decoder side intra mode derivation with a pseudo mode when referencing an intra prediction mode of the current block by an intra mode dependent tool; and
encoding or decoding the current block.

2. The method of claim 1, wherein the decoder side intra mode derivation is an intra mode derivation method that determines the actual intra prediction mode for the current block without referencing original samples of the current block.

3. The method of claim 1, wherein the decoder side intra mode derivation is template based intra mode prediction, and the template based intra mode prediction selects one mode as the actual intra prediction mode according to a difference between reconstructed samples and prediction samples of a template around the current block.

4. The method of claim 1, wherein the pseudo mode is DC mode, Planar mode, vertical mode, horizontal mode, diagonal mode, or a derived mode.

5. The method of claim 4, wherein the derived mode is derived from one or more neighboring intra prediction modes or a Most Probable Mode (MPM) candidate in a MPM set derived for the current block.

6. The method of claim 1, wherein when Residual Differential Pulse-Code Modulation (RDPCM) is enabled, sign hiding is disabled for the current block coded using the decoder side intra mode derivation when transform skip mode is used.

7. The method of claim 1, wherein an explicit flag is signaled for the current block indicating whether the current block is coded using the decoder side intra mode derivation.

8. The method of claim 1, wherein the intra mode dependent tool referencing the pseudo mode as the intra prediction mode of the current block comprises one or a combination of intra-mode-dependent coefficient scan, Most Probable Mode (MPM) derivation, Residual Differential Pulse-Code Modulation (RDPCM), Non-Separable Second Transform (NSST), Enhanced Multiple Transform (EMT), and Reference Sample Adaptive Filter (RSAF).

9. The method of claim 1, wherein the pseudo mode is referenced when deriving a coefficient scan order for intra-mode-dependent coefficient scan, and the actual intra prediction mode derived by the decoder side intra mode derivation is used for performing transforms, Enhanced Multiple Transform (EMT), Non-Separable Second Transform (NSST), or Reference Sample Adaptive Filter (RSAF) for the current block.

10. The method of claim 1, wherein the pseudo mode is referenced for deriving a Most Probable Mode (MPM) set for a neighboring block of the current block.

11. The method of claim 1, wherein an intra prediction mode of the current block is marked as unavailable for deriving a Most Probable Mode (MPM) set for a neighboring block of the current block.

12. The method of claim 1, wherein the pseudo mode is referenced by intra-mode-dependent coefficient scan or Most Probable Mode (MPM) derivation, and a second pseudo mode is referenced in one or more coding tools for reconstructing the current block including Enhanced Multiple Transform (EMT), Non-Separable Second Transform (NSST), and Reference Sample Adaptive Filter (RSAF), wherein the pseudo mode and the second pseudo mode are set to be the same mode or different modes.

13. The method of claim 1, wherein the current block is coded using the decoder side intra mode derivation or non-decoder side intra mode derivation, and the pseudo mode is also referenced by the intra mode dependent tool for the current block coded using the non-decoder side intra mode derivation in syntax signaling or parsing.

14. The method of claim 13, wherein the pseudo mode is referenced by the intra mode dependent tool for both blocks coded using the decoder side intra mode derivation and non-decoder side intra mode derivation only if the decoder side intra mode derivation is enabled; an actual intra prediction mode derived by the non-decoder side intra mode derivation is referenced by the intra mode dependent tool if the decoder side intra mode derivation is disabled.

15. The method of claim 1, wherein the current block coded using the decoder side intra mode derivation corresponds to a predefined intra prediction mode index, and same intra prediction mode signaling is applied to both blocks coded using the decoder side intra mode derivation and non-decoder side intra mode derivation.

16. The method of claim 1, wherein the actual intra prediction mode derived by the decoder side intra mode derivation is referenced by blocks in a different Coding Tree Unit (CTU) or a difference CTU-row, and the pseudo mode is referenced by blocks in a same CTU or a same CTU-row as the current block.

17. A method of processing video data in a video coding system, comprising:
receiving input data associated with a current block of the video data by a video encoder or receiving input data associated with a current block from a video bitstream by a video decoder;
determining a coarse grain intra prediction mode for the current block, wherein the coarse grain intra prediction mode is signaled explicitly in the video bitstream;
applying decoder side intra mode derivation to refine the coarse grain intra prediction mode of the current block by evaluating a number of intra prediction modes associated with the coarse grain intra prediction mode, and selecting one intra prediction mode among the number of intra prediction modes as a refined mode according to the decoder side intra mode derivation;
performing intra prediction for the current block based on the refined mode selected by the decoder side intra mode derivation; and
encoding the current block to generate the video bitstream by the video encoder or decoding the current block to generate decoded video by the video decoder.

18. The method of claim 17, wherein the decoder side intra mode derivation is an intra mode derivation method that determines the actual intra prediction mode for the current block without referencing original samples of the current block.

19. The method of claim 17, wherein the decoder side intra mode derivation is template based intra mode prediction, and the template based intra mode prediction selects one intra prediction mode among the number of intra prediction modes as a refined mode according to a difference between reconstructed samples and prediction samples of a template around the current block.

20. The method of claim 17, wherein the coarse grain intra prediction mode is signaled by using a Most Probable Mode (MPM) flag followed by an MPM index or a remaining mode index.

21. The method of claim 17, wherein a refine flag is signaled to decide whether the decoder side intra mode derivation is applied to refine the coarse grain intra prediction mode, and the coarse grain intra prediction mode is used to perform intra prediction if the refine flag indicates no refinement.

22. The method of claim 21, wherein the refine flag is only signaled when the coarse grain intra prediction mode is an angular mode.

23. The method of claim 17, wherein the number of intra prediction modes associated with the coarse grain intra prediction mode under evaluation is predefined or adaptively determined by signaling a syntax element in a slice level, picture level, or sequence level.

24. The method of claim 17, wherein at least one of MPM referencing, transform coefficient scan, Enhanced Multiple Transform (EMT), Non-Separable Second Transform (NSST), and sign hiding refers the explicitly signaled coarse grain intra prediction mode as an intra prediction mode of the current block.

25. The method of claim 17, wherein the decoder side intra mode derivation is applied to refine the coarse grain intra prediction mode only when the coarse grain intra prediction mode is an angular mode.

26. The method of claim 17, wherein the decoder side intra mode derivation is applied to refine the coarse grain intra prediction mode only when a block size of the current block satisfied a preset requirement.

27. The method of claim 17, wherein available modes are classified into a plurality of regions, the coarse grain intra prediction mode represents a selected region for the current block, and the decoder side intra mode derivation is applied to refine the coarse grain intra prediction by evaluating all modes in the selected region.

28. An apparatus of processing video data in a video coding system, wherein the apparatus comprising one or more electronic circuits configured for:
receiving input data associated with a current block of the video data;
determining an actual intra prediction mode for the current block by performing decoder side intra mode derivation, wherein the decoder side intra mode derivation is an intra mode derivation method that determines the actual intra prediction mode for the current block without referencing original samples of the current block;
performing intra prediction for the current block based on the actual intra prediction mode;
replacing the actual intra prediction mode determined by the decoder side intra mode derivation with a pseudo mode when referencing an intra prediction mode of the current block by an intra mode dependent tool; and
encoding or decoding the current block.

29. A non-transitory computer readable medium storing program instruction causing a processing circuit of an apparatus to perform video processing method, and the method comprising:
receiving input data associated with a current block of the video data;
determining an actual intra prediction mode for the current block by performing decoder side intra mode derivation, wherein the decoder side intra mode derivation is an intra mode derivation method that determines the actual intra prediction mode for the current block without referencing original samples of the current block;
performing intra prediction for the current block based on the actual intra prediction mode;
replacing the actual intra prediction mode determined by the decoder side intra mode derivation with a pseudo mode when referencing an intra prediction mode of the current block by an intra mode dependent tool; and
encoding or decoding the current block.

30. An apparatus of processing video data in a video coding system, wherein the apparatus comprising one or more electronic circuits configured for:
receiving input data associated with a current block of the video data by a video encoder or receiving input data associated with a current block from a video bitstream by a video decoder;
determining a coarse grain intra prediction mode for the current block, wherein the coarse grain intra prediction mode is signaled explicitly in the video bitstream;
applying decoder side intra mode derivation to refine the coarse grain intra prediction mode of the current block by evaluating a number of intra prediction modes associated with the coarse grain intra prediction mode, and selecting one intra prediction mode among the number of intra prediction modes as a refined mode according to the decoder side intra mode derivation, wherein the decoder side intra mode derivation is an intra mode derivation method that determines the actual intra prediction mode for the current block without referencing original samples of the current block;
performing intra prediction for the current block based on the refined mode selected by the decoder side intra mode derivation; and
encoding the current block to generate the video bitstream by the video encoder or decoding the current block to generate decoded video by the video decoder.

31. A non-transitory computer readable medium storing program instruction causing a processing circuit of an apparatus to perform video processing method, and the method comprising:
receiving input data associated with a current block of the video data by a video encoder or receiving input data associated with a current block from a video bitstream by a video decoder;
determining a coarse grain intra prediction mode for the current block, wherein the coarse grain intra prediction mode is signaled explicitly in the video bitstream;
applying decoder side intra mode derivation to refine the coarse grain intra prediction mode of the current block by evaluating a number of intra prediction modes associated with the coarse grain intra prediction mode, and selecting one intra prediction mode among the number of intra prediction modes as a refined mode according to the decoder side intra mode derivation, wherein the decoder side intra mode derivation is an intra mode derivation method that determines the actual intra prediction mode for the current block without referencing original samples of the current block;
performing intra prediction for the current block based on the refined mode selected by the decoder side intra mode derivation; and
encoding the current block to generate the video bitstream by the video encoder or decoding the current block to generate decoded video by the video decoder.
